(19) United States
(12) Patent Application Publication
(10) Pub. No.: US 2010/0227482 A1
(43) Pub. Date: Sep. 9, 2010

(54) MECHANICALLY SUPPORTED CONTACT AND ELECTRICAL CONNECTOR UTILIZING THE SAME

(75) Inventors: ALAN ROBERT MACDOUGALL, BEAVERTON, OR (US); STEVEN J. MILLARD, MECHANICSBURG, PA (US); JAMES A. LEIDY, HUMMELSTOWN, PA (US)

Correspondence Address: ROBERT J. KAPALKA;TYCO TECHNOLOGY RESOURCES, 4550 NEW LINDEN HILL ROAD, SUITE 140, WILMINGTON, DE, 19808, US

(73) Assignee: TYCO ELECTRONICS CORPORATION, BERWYN, PA (US)

(21) Appl. No.: 12/400,527

(22) Filed: Mar. 9, 2009

(51) Int. Cl. H01R 12/00; H01R 13/02

(52) U.S. Cl. 439/76.1; 439/884; 439/78

(57) ABSTRACT

An electrical contact includes a conductor extending along a length between a tail and a tip. The conductor has a front mating interface configured to be engaged by a mating component such that the conductor is deflected rearwardly by the mating component. A mechanical support beam is disposed along a rear of the conductor and is configured to provide mechanical support for the conductor to resist rearward deflection of the conductor. Electrical conductivity of the conductor is greater than electrical conductivity of the mechanical support beam. Mechanical strength of the mechanical support beam is greater than mechanical strength of the conductor. Optionally, a flexible substrate may be provided between the conductor and the mechanical support beam, where the conductor has a length that extends along at least a portion of the length of the conductor. The flexible substrate may have first and second sides with the first side being secured to the conductor and the second side being secured to the mechanical support beam.

### BACKGROUND OF THE INVENTION

The subject matter herein relates generally to contacts, and more particularly to highly conductive contacts that are mechanically supported.

Electrical connectors include one or more contacts for making electrical connection with mating contacts of a mating component. One type of electrical connector is a socket connector that includes an array of contacts arranged in parallel along a slot that receives a portion of the mating component. One particular type of socket connector is a card edge connector. Card edge connectors receive an edge of a circuit board that has contact pads at the edge thereof that are mated with corresponding socket contacts. The contacts transmit either power or data across the mating interface between the electrical connector and the mating component.

Known electrical connectors are not without disadvantages. For instance, the electrical performance of each contact is determined by the physical properties of the contact, such as the type of material of the contact. The conductivity of the contact is based, at least in part, on the type of material of the contact. For example, copper is an excellent conductor, and the higher the concentration of copper in the contact, the better the conductivity of the contact. However, contacts with high concentrations of copper are generally mechanically unstable. In some particular applications, the contacts are substantially or even entirely supported along their length by the housing of the electrical connector. As a result, the contacts do not need to be mechanically stable in and of themselves because the housing supports the contacts. In other applications, the contacts are free-standing and need to support themselves along a substantial portion of the length. As a result, the contacts are made from an alloy that includes a lower concentration of copper and a higher concentration of other metal(s) having higher strength but lower conductivity. One particular example of a material that is commonly used in electrical connectors is phosphor-bronze, which is an alloy of copper with 3.5% to 10% tin and a significant phosphorus content of up to 1%. Another example of a material commonly used in electrical connectors is iron-modified tin-brass. Many others exist and are in use. These materials typically have between approximately 10% to 18% of the conductivity of pure copper.

With the ever increasing trend in miniaturization and increase in performance and throughput, the typical phosphor-bronze contacts are being pushed to their limits in terms of power and/or data throughput, particularly as the size of the contacts are reduced to fit within smaller electrical connectors. A need remains for contacts that have high conductivity and low resistance. A need remains for contacts that have sufficient mechanical stability to be free-standing. A need remains for contacts that can be produced in a cost effective manner.

### BRIEF DESCRIPTION OF THE INVENTION

In one embodiment, an electrical contact is provided including a conductor extending along a length between a tail and a tip. The conductor has a front mating interface configured to be engaged by a mating component such that the conductor is deflected rearwardly by the mating component. A mechanical support beam is disposed along a rear of the conductor and is configured to provide mechanical support for the conductor to resist rearward deflection of the conductor. Electrical conductivity of the conductor is greater than electrical conductivity of the mechanical support beam. Mechanical strength of the mechanical support beam is greater than mechanical strength of the conductor. Optionally, a flexible substrate may be provided between the conductor and the mechanical support beam, where the conductor has a length that extends along at least a portion of the length of the conductor. The flexible substrate may have first and second sides with the first side being secured to the conductor and the second side being secured to the mechanical support beam.

In another embodiment, an electrical contact is provided and includes a conductor extending along a length between a tail and a tip. The conductor having an inner surface and an outer surface and the outer surface defining a mating interface along a portion of the length. The tail adapted for engaging a first mating component and the mating interface adapted for engaging a second mating component. The conductor being configured to electrically interconnect the first and second mating components. The contact also includes a flexible substrate having a length that extends along at least a portion of the length of the conductor. The flexible substrate has first and second sides with the first side being secured to the inner surface of the conductor. The contact also includes a mechanical support beam having a length that extends along at least a portion of the length of the conductor. The mechanical support beam has an inner surface and an outer surface. The inner surface is secured to at least a portion of the second side of the flexible substrate, wherein the flexible substrate allows relative movement between the mechanical support beam and the conductor.

Optionally, the conductor, the flexible substrate, and the mechanical support beam may have widths that are approximately equal to one another. The conductor may define a single conductive path between the tail and the tip. The conductor and the mechanical support beam may have different mechanical and electrical properties from one another, where the conductor is manufactured from a material having a higher conductivity than the mechanical support beam, and where the mechanical support beam is manufactured from a material having a higher mechanical strength than the conductor. The mechanical support beam may be electrically isolated from the conductor and from the first and second mating components.

In another embodiment, an electrical connector is provided including a housing having a slot configured to receive a mating connector with a contact channel open along at least a portion of the slot, and an electrical contact securely held within the contact channel. The contact has a conductor extending along a length between a tail and a tip. The conductor has a front mating interface configured to be engaged by a mating component such that the conductor is deflected rewardly by the mating component. A mechanical support beam is disposed along a rear of the conductor and is configured to provide mechanical support for the conductor to resist rearward deflection of the conductor. Electrical conductivity of the conductor is greater than electrical conductivity of the mechanical support beam. Mechanical strength of the mechanical support beam is greater than mechanical strength of the conductor.

In a further embodiment, a socket connector is provided including a socket housing having a slot configured to receive a planar connector having mating contacts arranged on at least one side of the planar connector. The housing has a plurality of contact channels and socket contacts are aligned with one another in one or more rows. The socket contacts are securely held within corresponding contact channels, and each socket contact has a conductor having an inner surface and an outer surface. Each socket contact has a flexible substrate having first and second sides with the first side being secured to the inner surface of the conductor. Each socket contact has a mechanical support beam secured to the second side of the flexible substrate. Each socket contact includes a tip, a base section, and a mating section arranged between the base section and the tip. The base section is securely received within the corresponding contact channel and the mating section extends into the slot for engagement with respective mating contacts when the planar connector is received in the slot. Each conductor and mechanical support beam have different mechanical and electrical properties from one another, where the conductor is manufactured from a material having a higher conductivity than the mechanical support beam, and where the mechanical support beam is manufactured from a material having a higher mechanical strength than the conductor.

### BRIEF DESCRIPTION OF THE DRAWINGS

FIG. 1 is a top perspective view of an electrical connector that includes an array of contacts formed in accordance with an exemplary embodiment.

FIG. 2 is a side view of one of the contacts shown in FIG. 1.

FIG. 3 is a front perspective view of the contact shown in FIG. 2.

FIG. 4 is a rear perspective view of the contact shown in FIG. 2.

FIG. 5 illustrates the contact shown in FIG. 2 in a deflected position, showing a non-deflected position of the contact in phantom.

FIG. 6 is a side view of an alternative contact for the electrical connector shown in FIG. 1.

### DETAILED DESCRIPTION OF THE INVENTION

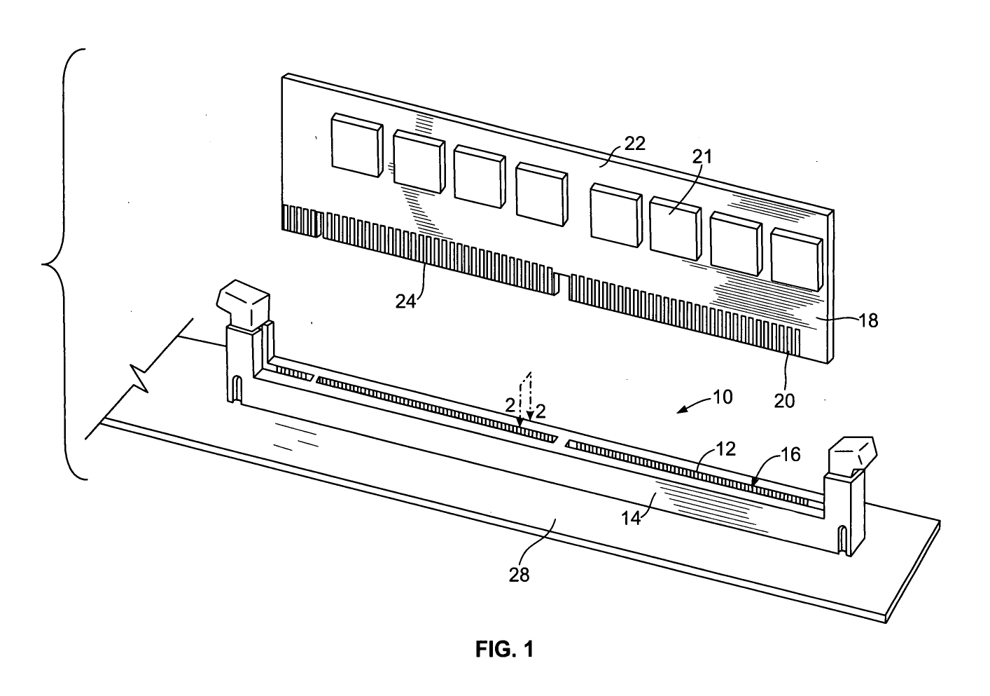

FIG. 1 is a top perspective view of an electrical connector 10 that includes an array of contacts 12 formed in accordance with an exemplary embodiment. In the illustrated embodiment, the electrical connector 10 is represented by a socket connector, and may be referred to hereinafter as socket connector 10. The contacts 12 may likewise be referred to as socket contacts 12. In other alternative embodiments, the electrical connector 10 may be a different type of connector other than a socket connector. The socket connector 10 is thus provided for illustrative purposes only, and the subject matter herein is not intended to be limited to a socket connector.

The electrical connector 10 includes a housing 14 that has a slot 16 adapted to receive a mating component 18 having mating contacts 20 and one or more electrical components 21 electrically connected to the mating contacts 20. In the illustrated embodiment, the mating component 18 is represented by a power module, however the mating component 18 is not intended the limited thereto. The mating component 18 includes a circuit board 22 having an edge 24. The mating contacts 20 are provided on one or more sides of the circuit board 22 near or at the edge 24. The mating component 18 thus represents a card edge component matable with the electrical connector 10. In an alternative embodiment, the mating component 18 may be a different type of component such as a plug connector having a housing matable with the electrical connector 10.

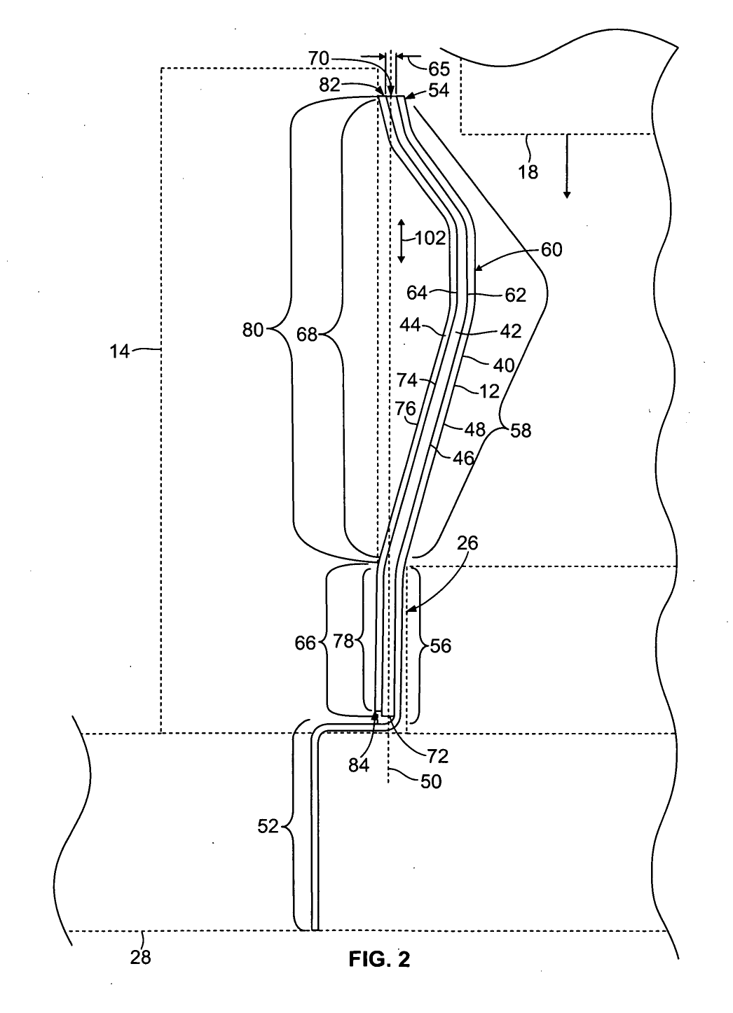

The housing 14 includes a plurality of contact channels 26 (shown in FIG. 2) that receive the individual contacts 12. The contact channels 26 are defined by interior walls of the housing 14. The contact channels 26 are open along at least a portion of the slot 16 such that the contacts 12 may be exposed to the mating component 18 when the mating component is received in the slot 16. Optionally, the contacts 12 may extend from the contact channels 26 into the slot 16 for engaging the mating component 18. The contacts 12 are securely held within the contact channels 26 and portions of the contacts 12 are positioned away from the housing 14 such that the contacts 12 are freestanding.

The electrical connector 10 is mounted to a circuit board 28. The contacts 12 are individually terminated to the circuit board 28 such as by through hole mounting, surface mounting, and the like. An electrical circuit is created between the mating contacts 20 of the mating component 18 and the circuit board 28 via the contacts 12. The contacts 12 may be power contacts, signal contacts or ground contacts. In an exemplary embodiment, some of the contacts 12 represent power contacts and some of the contacts 12 represent signal contacts. In other embodiments, all of the contacts 12 represent power contacts or all of contacts 12 represent signal contacts.

FIG. 2 is a side view of one of the contacts 12 illustrating the housing 14 and the circuit board 28 in phantom. The contact 12 has several layers including a conductor 40, flexible substrate 42 and a mechanical support beam 44. The flexible substrate 42 is positioned between the conductor 40 and the mechanical support beam 44.

The conductor 40 includes an inner surface 46 and an outer surface 48. The outer surface 48 defines a front mating interface 60 for mating with the mating component 18. The conductor 40 extends along a length in a longitudinal direction generally along a longitudinal axis 50 of the contact 12. In an exemplary embodiment, the conductor 40 is fabricated from a metal material that exhibits good electrical properties. For example, the conductor 40 may be fabricated from an alloy having a high concentration of copper, for example more than approximately 30% copper. The conductor 40 may be manufactured from a material having a conductivity of approximately one-half that of pure copper. The conductor 40 may have a higher conductivity which is closer to the conductivity of pure copper in alternative embodiments. The conductor 40 may be pure copper in some embodiments. The conductor 40 may be manufactured from a material having stability characteristics in which the conductor 40 is considered mechanically weak in that the conductor 40 is unable to mechanically support itself during normal operation. The conductor 40 may not have adequate spring-back against the mating component 18 to maintain adequate bias against the mating component 18 when mated thereto. For example, the concentration of copper within the conductor 40 may be sufficiently high such that the conductor 40 is incapable of being freestanding in normal operation during mating with the mating component 18. Rather than bulking-up the conductor 40 by increasing the cross-sectional area of the conductor 40, which adds cost to the contact 12, or changing the type of material, which may decrease the conductivity of the conductor 40, the mechanical support beam 44 is utilized to overcome the mechanical shortcomings of the conductor 40.

The conductor 40 includes a tail 52 at one end thereof and a tip 54 at the other end thereof. The tail 52 is terminated to the circuit board 28. For example, the tail 52 may extend into a through hole of the circuit board 28 and may be soldered or press-fit therein.

The conductor 40 includes a base section 56 and a mating section 58. The base section 56 is arranged between the tail 52 and the mating section 58. The mating section 58 is arranged between the base section 56 and the tip 54. The conductor 40 may include other sections as well. The base section 56 is securely held within the contact channel 26 and may engage one or more of the walls defining the contact channel 26. At least a portion of the mating section 58 defines the front mating interface 60 that is configured to engage and electrically connect with the mating contacts 20 of the mating component 18.

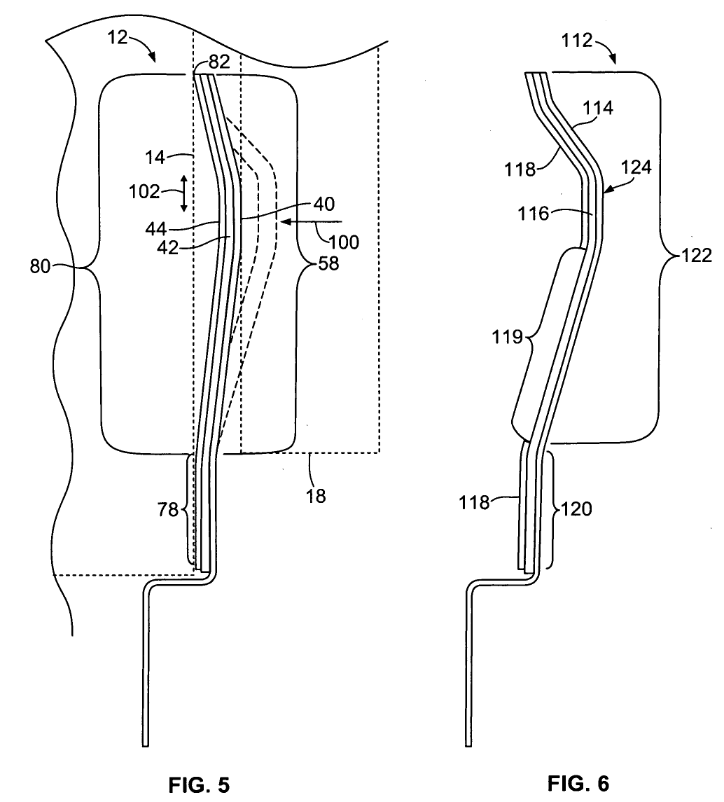

The mating section 58 of the conductor 40 is bowed outward generally between the base section 56 and the tip 54. Such an unmated shape positions the mating interface 60 within the slot 16 (shown in FIG. 1) for engagement with the mating component 18 when the mating component 18 is received in the slot 16. When mated, at least a portion of the mating section 58 may be flexed and/or deflected inward toward the longitudinal axis 50 by the mating component 18. The mating section 58 changes shape from the unmated shape (shown in FIG. 2) to a mated shape (shown in FIG. 5), where the mated shape has the mating section 58 closer to planar. In an exemplary embodiment, the tip 54 is substantially aligned with the base section 56 along the longitudinal axis 50.

The flexible substrate 42 includes a first side 62 and a second side 64. In an exemplary embodiment, the flexible substrate 42 is a nonconductive sheet or film. The flexible substrate 42 has a thickness 65, such as, but not limited to, approximately 1 mil. Optionally, the flexible substrate 42 may be fabricated from a polyimide material, or other similar materials.

The flexible substrate 42 extends along a length in a longitudinal direction 102 generally along the longitudinal axis 50. The first side 62 is secured to the inner surface 46 of the conductor 40 such as by bonding the flexible substrate 42 and the conductor 40 to one another. Optionally, an adhesive may be used between the flexible substrate 42 and the conductor 40. The adhesive may be selectively placed. The second side 64 is secured to the mechanical support beam 44 such as by bonding the flexible substrate 42 and the mechanical support beam 44 to one another. Optionally, an adhesive may be used between the flexible substrate 42 and the mechanical support beam 44. The adhesive may be selectively placed. In an exemplary embodiment, the flexible substrate 42 electrically isolates the conductor 40 from the mechanical support beam 44. The flexible substrate 42 allows relative movement between the mechanical support beam 44 and the conductor 40, such as during deflection of the mating section 58.

The flexible substrate 42 includes a base section 66 and a mating section 68. The base section 66 is substantially aligned with the base section 56 of the conductor 40. The mating section 68 is substantially aligned with the mating section 58 of the conductor 40. The mating section 68 is arranged between the base section 66 and a tip 70 of the flexible substrate 42. The tip 70 is generally opposite a base end 72 of the flexible substrate 42. The flexible substrate 42 may include other sections as well.

The mechanical support beam 44 includes an inner surface 74 and an outer surface 76. The mechanical support beam 44 extends along a length in the longitudinal direction 102 generally along the longitudinal axis 50 of the contact 12. In an exemplary embodiment, the mechanical support beam 44 is fabricated from a metal material having different mechanical and electrical properties than the conductor 40. The mechanical support beam 44 is fabricated from a metal material exhibiting good mechanical strength properties. For example, the mechanical support beam 44 is fabricated from a phosphor-bronze alloy, a beryllium-copper alloy, a copper-nickel-silicon alloy, and the like.

The mechanical support beam 44 includes a base section 78 and a mating section 80. The base section 78 is substantially aligned with the base section 56 of the conductor 40. The mating section 80 is substantially aligned with the mating section 58 of the conductor 40. The mating section 80 is arranged between the base section 78 and a tip 82 of the mechanical support beam 44. The tip 82 is generally opposite a base end 84 of the mechanical support beam 44. The mechanical support beam 44 may include other sections as well.

In an exemplary embodiment, the tip 82 is provide proximate to and/or abuts a surface of the housing 14 to support the top end of the contact 12 relative to the slot 16. The tip 82 is held generally in-line with the base section 78 along the longitudinal axis 50. The mating section 80 is bowed outward from the longitudinal axis 50.

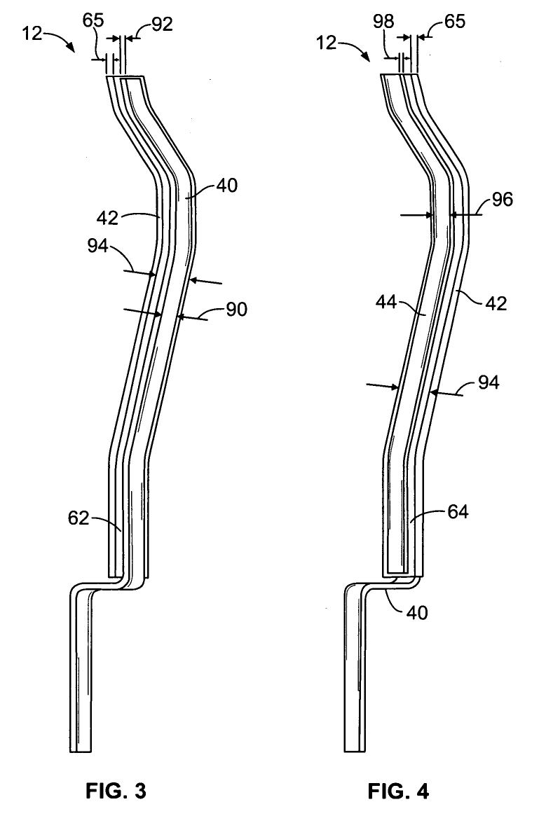

FIG. 3 is a front perspective view of the contact 12. FIG. 4 is a rear perspective view of the contact 12. FIGS. 3 and 4 illustrates the various layers of the contact 12 with the conductor 40 secured to the first side 62 of the flexible substrate 42 and the mechanical support beam 44 secured to the second side 64 of the flexible substrate 42.

The conductor 40 has a cross-section along the length thereof defined by a width 90 and a thickness 92. The width 90 is greater than the thickness 92. In an exemplary embodiment, the width 90 is generally constant along the length and the thickness 92 is generally constant along the length. The conductor 40 is stamped from a blank and formed into a final, nonplanar shape. The conductor 40 may be formed into the final shape either prior to coupling with the flexible substrate 42 or after coupling with the flexible substrate 42.

The flexible substrate 42 has a cross-section along the length thereof defined by a width 94 and the thickness 65. The width 94 is greater than the thickness 65. In an exemplary embodiment, the width 94 is generally constant along the length and the thickness 65 is generally constant along the length.

The mechanical support beam 44 has a cross-section along the length thereof defined by a width 96 and a thickness 98. The width 96 is greater than the thickness 98. In an exemplary embodiment, the width 96 is generally constant along the length and the thickness 98 is generally constant along the length. The mechanical support beam 44 is stamped from a different blank than the conductor 40, where the blanks are made from different materials having different mechanical and electrical properties. The mechanical support beam 44 is formed into a final nonplanar shape that mirrors the final shape of the conductor 40. Optionally, the mechanical support beam 44 and the conductor 40 may be formed simultaneously such that the mechanical support beam 44 and the conductor 40 have the same shape. The flexible substrate 42 and/or the mechanical support beam 44 may be secured to the conductor 40 prior to forming the conductor 40 into the final shape.

In an exemplary embodiment, the widths 90, 94, 96 of the conductor 40, flexible substrate 42 and mechanical support beam 44, respectively, may be approximately equal to one another. In the illustrative embodiment, the width 94 of the flexible substrate 42 is approximately equal to the widths 90, 96, but is slightly wider than the widths 90, 96. The additional width of the flexible substrate 42 may be provided for handling the contact 12.

FIG. 5 illustrates the contact 12 in a deflected position, showing a non-deflected position of the contact 12 in phantom as well as positions of the housing 14 and mating component 18. During operation, when the mating component 18 is loaded into the slot 16 (shown in FIG. 1), the mating component 18 engages the mating interface 60 (shown in FIG. 2) of the conductor 40. The conductor 40 is forced inward by the mating component 18.

The mechanical support beam 44 provides mechanical support for the conductor 40 to hold the general shape of the conductor 40 and generally force the conductor 40 outward against the mating component 18. The base section 78 and the tip 82 of the mechanical support beam 44 are held by the housing 14 while the mating sections 58, 80 of the conductor 40 and mechanical support beam 44, respectively, are deflected inward in a deflection direction 100. For example, the base section 78 may be held in place with respect to the housing 14 and the tip 82 may slide along a wall of the housing 14. The wall of the housing 14 blocks inward movement of the tip 82. The deflection direction 100 is substantially transverse to the longitudinal direction 102. Optionally, the deflection direction 100 may be perpendicular to the longitudinal direction 102.

When the mating sections 58, 80 are flexed inward, the mating sections 58, 80 change shape from the unmated shape (shown in phantom) to the mated shape in which the mating sections 58, 80 become relatively flatter. The shape of the mating section 58 of the conductor 40 may be changed differently than the mating section 80 of the mechanical support beam 44. For example, the mating section 80 may flatten out more than the mating section 58. The mating section 80 may become more straightened than the mating section 58.

The flexible substrate 42 allows relative movement between the mechanical support beam 44 and the conductor 40. For example, the flexible substrate 42 may be stretched or manipulated to accommodate the change in shape of the mating sections 58, 80.

FIG. 6 is a side view of an alternative contact 112 for the electrical connector 10 (shown in FIG. 1). The contact 112 includes a conductor 114, a flexible substrate 116, and a plurality of mechanical support beams 118. The mechanical support beams 118 are separated by a gap 119. Any number of mechanical support beams 118 may be provided an alternative embodiment.

The conductor 114 includes a base section 120 and a mating section 122. The mating section 122 has a mating interface 124. In the illustrated embodiment, the mechanical support beams 118 are aligned with the base section 120 and the mating interface 124 of the conductor 114. The base section 120 and the mating interface 124 are areas of the conductor 114 having additional mechanical support. The base section 120 has additional mechanical support because the base section 120 is received within the contact channel 26 (shown in FIG. 2). The mating interface 124 has additional mechanical support because the mating section 122 engages the mating component 18 (shown in FIG. 2) and is flexed when engaged by the mating component 18.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. An electrical contact comprising:
a conductor extending along a length between a tail and a tip, the conductor having a front mating interface configured to be engaged by a mating component such that the conductor is deflected rearwardly by the mating component;
a mechanical support beam disposed along a rear of the conductor and configured to provide mechanical support for the conductor to resist rearward deflection of the conductor;
wherein electrical conductivity of the conductor is greater than electrical conductivity of the mechanical support beam; and
wherein mechanical strength of the mechanical support beam is greater than mechanical strength of the conductor.

2. The contact of claim 1, further comprising a flexible substrate having a length that extends along at least a portion of the length of the conductor, the flexible substrate having first and second sides with the first side being secured to the conductor and the second side being secured to the mechanical support beam.

3. The contact of claim 1, wherein the conductor is stamped from a blank and formed into a final, nonplanar shape, and wherein the mechanical support beam is stamped from a different blank and formed into a final nonplanar shape that mirrors the final shape of at least a portion of the conductor.

4. The contact of claim 1, wherein the conductor is stamped from a blank and formed into a final nonplanar shape, the mechanical support beam being secured to the conductor prior to forming the conductor into the final shape such that the mechanical support beam and the conductor are formed simultaneously.

5. The contact of claim 1, wherein the length of the conductor is measured generally in a longitudinal direction the conductor being configured to deflect inward in a deflection direction that is transverse to the longitudinal direction when the conductor engages the first mating component, a shape of the conductor and a shape of the mechanical support beam changing relative to one another as the conductor is moved in the deflection direction.

6. An electrical contact comprising:
a conductor extending along a length between a tail and a tip, the conductor having an inner surface and an outer surface, the outer surface defining a mating interface along a portion of the length, the tail adapted for engaging a first mating component and the mating interface adapted for engaging a second mating component, the conductor being configured to electrically interconnect the first and second mating components;
a flexible substrate having a length that extends along at least a portion of the length of the conductor, the flexible substrate having first and second sides with the first side being secured to the inner surface of the conductor, and
a mechanical support beam having a length that extends along at least a portion of the length of the conductor, the mechanical support beam having an inner surface and an outer surface, the inner surface being secured to at least a portion of the second side of the flexible substrate, wherein the flexible substrate allows relative movement between the mechanical support beam and the conductor.

7. The contact of claim 6, wherein the conductor, the flexible substrate, and the mechanical support beam have widths that are approximately equal to one another.

8. The contact of claim 6, wherein the conductor defines a single conductive path between the tail and the tip.

9. The contact of claim 6, wherein the conductor and the mechanical support beam have different mechanical and electrical properties from one another, the conductor being manufactured from a material having a higher conductivity than the mechanical support beam, the mechanical support beam being manufactured from a material having a higher mechanical strength than the conductor.

10. The contact of claim 6, wherein the conductor has conductivity of at least one-half of conductivity of pure copper.

11. The contact of claim 6, wherein the mechanical support beam is electrically isolated from the conductor and from the first and second mating components.

12. The contact of claim 6, wherein the conductor is stamped from a blank and formed into a final nonplanar shape, at least one of the flexible substrate and the mechanical support beam being secured to the conductor prior to forming the conductor into the final shape.

13. The contact of claim 6, wherein more than one mechanical support beams are secured to the second side of the flexible substrate along different sections of the length of the flexible substrate, the mechanical support beams being separated from one another such that a gap exists between the mechanical support beams.

14. The contact of claim 6, wherein the length of the conductor is measured generally in a longitudinal direction, the conductor being configured to deflect inward in a deflection direction that is transverse to the longitudinal direction when the conductor engages the first mating component, a shape of the conductor and a shape of the mechanical support beam changing relative to one another as the conductor is moved in the deflection direction, the flexible substrate accommodating the relative changes in shape.

15. An electrical connector comprising:
a housing having a slot configured to receive a mating component, the housing having a contact channel open along at least a portion of the slot; and
an electrical contact securely held within the contact channel, the electrical contact comprising:
a conductor extending along a length between a tail and a tip, the conductor having a front mating interface configured to be engaged by a mating component such that the conductor is deflected rearwardly by the mating component; and
a mechanical support beam disposed along a rear of the conductor and configured to provide mechanical support for the conductor to resist rearward deflection of the conductor, wherein electrical conductivity of the conductor is greater than electrical conductivity of the mechanical support beam, and wherein mechanical strength of the mechanical support beam is greater than mechanical strength of the conductor.

16. The electrical connector of claim 15, wherein the electrical contact further includes a flexible substrate having a length that extends along at least a portion of the length of the conductor, the flexible substrate having first and second sides with the first side being secured to the conductor and the second side being secured to the mechanical support beam.

17. The electrical connector of claim 16, wherein the mating section is bowed outward towards the slot and is deflectable inward in a deflection direction when the conductor engages the planar component, the deflection direction being transverse to a length of the contact, a shape of the conductor and a shape of the mechanical support beam changing relative to one another as the conductor is moved in the deflection direction, the flexible substrate accommodating the relative changes in shape.

18. The electrical connector of claim 16, wherein the mating section is bowed outward generally between the base section and the tip, the mating section being flexed inward by the planar component from an unmated shape to a mated shape in which the mating section is closer to planar than the unmated shape, the mechanical support beam being straightened more than the conductor, the flexible substrate allowing relative movement between the mechanical support beam and the conductor.

19. The electrical connector of claim 15, wherein the housing includes a plurality of contact channels open along different portions of the slot, and wherein a plurality of the electrical contacts are provided and arranged within corresponding contact channels, each of the contacts being separate and distinct from one another.

20. The electrical connector of claim 15, wherein the portion of the conductor including the mating interface extends out of the contact channel into the slot for engagement with the mating connector when the mating connector is loaded into the slot, the mechanical support beam being adapted for providing a biasing force against the mating connector when the mating connector is loaded into the slot
